(19) United States
(12) Patent Application Publication
(10) Pub. No.: US 2009/0077660 A1
(43) Pub. Date: Mar. 19, 2009

(54) Security Module and Method for Controlling and Monitoring the Data Traffic of a Personal Computer

(76) Inventor: Holger Mahltig, Berlin (DE)

Correspondence Address: IP STRATEGIES, 12 1/2 WALL STREET, SUITE E, ASHEVILLE, NC, 28801, US

(21) Appl. No.: 11/573,008

(22) PCT Filed: Jul. 31, 2005
(86) PCT No.: PCT/DE2005/001368

§ 371 Date: Nov. 25, 2008

(30) Foreign Application Priority Data
Aug. 2, 2004 (DE) 10 2004 038 040.6
Mar. 30, 2005 (DE) 10 2005 014 837.9

(51) Int. Cl. G06F 21/00

(52) U.S. Cl. 726/22

(57) ABSTRACT

The invention disclosed herein relates to a security module (1) and a method for controlling and monitoring data traffic of a personal computer (10). The security module (1) comprises several functional components each implemented by hardware and/or software, wherein the several functional components comprise a programmable logic component (2) in which, by means of programming, a process and control unit for processing electronic data being exchanged between the several functional components is implemented, a processor terminal (3) connected to the programmable logic component (2) for exchanging electronic data with a central processor (11) of the personal computer (10), a hard disk terminal (4) connected to the programmable logic component (2) for exchanging electronic data with a hard disk (12) of the personal computer (10), terminals of peripheral devices (5) connected to the programmable logic component (2) for exchanging electronic data with the peripheral devices (13) for data input and/or data output connected to the personal computer (10), and a memory module (6) connected to the programmable logic component (2) and containing initialization data for the logic component (2), and where the programmable logic component (2) designed to functionalize itself independently in order to make the process and control unit ready for use in the programmable logic component (2) by means of the initialization data.

The invention disclosed herein relates to apparatuses and methods providing for data security of personal computers.

### STATE-OF-THE-ART

Modern personal computers show growing complexity both in regard to their hardware configuration and to their software. They do not only comprise a multitude of internal devices, i.e. those accommodated inside the system cover of a personal computer, e.g. clock generators with own control logic components, and external devices, i.e. peripheral devices and other components accommodated outside the system cover of a personal computer, in addition they have to perform a multitude of processes simultaneously. Moreover, using communication networks such as the Internet, today's personal computers are in many different ways linked via networks to other personal computers and/or other data processing means, such as servers, databases, printers or as the case may be.

Besides the speed of data processing and data transfer, data security is of great importance. On the one hand, the growing complexity results in unauthorized modifications of data which may not be avoided, no matter if caused by faulty software or operating errors. On the other hand, increasing networking makes it more and more difficult to prevent unauthorized access to data by e.g. computer viruses.

Computer bugs, operating errors and computer viruses are widely regarded as different sources for data errors which may even cause loss of data, and the attempts to avoid those sources are based on different approaches. For example, in order to diminish operating errors the user's access to specific data may be limited; it may be only granted after having typed in the correct authentification code. Hard disks may be divided into segments not freely accessible for the user. Even if these precautionary measures may be implemented via hardware, they will only restrict the amount of data accessible via this insecure way. Nevertheless, this data may still be corrupted, e.g. by operating errors. Such precautionary measures are mostly implemented via software and may be bypassed by computer viruses already located in the software.

Conventional programs available on the market to fight computer viruses, so-called anti-virus programs, operate in such a way that the entire memory of the personal computer is searched through. All data residing in the memory is compared with program codes of computer viruses so far known and in the event of a match protective measures are taken to remove those malicious files. In so doing, only protection from computer viruses which have been known so far may be obtained. Thus, anti-virus programs are as ineffective with new computer viruses which have not been known yet as they are with operating errors or computer bugs. Anti-virus programs simply residing as software in the memory of the personal computer may also be at the risk of becoming the target of a computer virus' attack.

U.S. Pat. No. 5,289,540 discloses a plug-in card controlling the data flow between the drives and the other hardware components of a personal computer. The plug-in card is set up by the operating system of the personal computer when initializing the PC system. The program used for controlling the plug-in card resides in the main memory of the personal computer and checks for the access rights of a user by authentification measures asking for the user's name and password. Similar to anti-virus applications, the program used for controlling the plug-in card which resides in the main memory of the personal computer is at the risk of being modified by a computer bug, an operating error and/or by a computer virus as well. However, successful authentification does not necessarily mean that all the user's accesses to the data made available to him are allowed and that they are accurately interpreted by the software.

U.S. Pat. No. 6,564,326 discloses a method wherein a coprocessor is integrated in a personal computer with a processor. The coprocessor will monitor the personal computer until it is ensured that the personal computer is free from malicious codes, e.g. computer viruses. Afterwards, the coprocessor uncouples from the data transfer of the personal computer. The principal disadvantage of this method is that neither data corruption caused by operating errors nor those caused by computer bugs are noticed. On the other hand, there is the similar problem also arising with anti-virus programs, i.e. users have to know what programs are malicious and what programs are not.

### The Invention

The purpose of the invention is to provide a security module and a method for controlling and monitoring data transfer of a personal computer thus guaranteeing increased security when operating a personal computer.

This purpose is accomplished by a security module according to the independent claim 1 and a method according to the independent claim 11.

In accordance with the present invention, a security module for controlling and monitoring the data transfer of a personal computer comprising several functional components each implemented by hardware and/or software is provided, wherein the several functional components comprise a programmable logic component in which, by means of programming, a process and control unit for processing electronic data being exchanged between the several functional components is implemented, a processor terminal connected to the programmable logic component for exchanging electronic data with a central processor of the personal computer, a hard disk terminal connected to the programmable logic component for exchanging electronic data with a hard disk of the personal computer, terminals of peripheral devices connected to the programmable logic component for exchanging electronic data with the peripheral devices for data input and/or data output connected to the personal computer, and a memory module connected to the programmable logic component and containing initialization data for the logic component, and where the programmable logic component designed to functionalize itself independently in order to make the process and control unit ready for use in the programmable logic component by means of the initialization data.

Compared to the state-of-the-art it is the advantage of the security module that operating independently from the personal computer a programmable logic component controls and monitors the data transfer of the personal computer. This means the central processor of the personal computer will not be able to control the programmable logic component. By monitoring the data of the personal computer exchanged between the several components during data traffic, e.g. between the central processor, the hard disk and the peripheral devices, the programmable logic component is able to prevent any unwanted access to data originating from computer bugs, operating errors and/or computer viruses. Since the programmable logic component is designed to functionalize itself independently, it may interfere using its control and monitoring functions even when the personal computer is booted.

In a particularly advantageous embodiment of the invention, the functional components form an encapsulated system. This means the functional components are combined to form a system that operates independently. Thus, malfunctions occurring in the security module are easier to detect, and the security module may be replaced without any further difficulties.

In a more user-friendly embodiment of the invention, the several functional components are implemented on a plug-in card, allowing a conventional personal computer to be equipped with the security module without the need of modifying the architecture of the personal computer.

In a compact embodiment of the invention, the several functional components are implemented on a motherboard of the personal computer. On the one hand, data traffic lines between the central processor of the personal computer and the security module are cut short resulting in an increase in speed. On the other hand, additional external connections to the motherboard, such as connections to plug-in cards, are kept free.

In another preferred embodiment of the invention, the several functional components are at least partly realized in a chip set of the motherboard, thus minimizing the required space for the security module. This represents a considerable advantage, above all, when used in a mobile personal computer.

In a functional embodiment of the invention, the several functional components are at least partly realized in a Northbridge chip of the chip set of the motherboard. Since Northbridge chips connect the central processor to the other hardware of the personal computer, this embodiment helps at least partly to spare interfaces from the security module to the peripheral devices. Sparing interfaces means increasing speed at the same time as the security module now is able to communicate directly with the central processor instead of being dependent on communication via a bus system.

In an advantageous embodiment of the invention, the memory module is realized in a RAM memory of the personal computer. This means that an additional memory for the security module may be partly or completely spared resulting in a more cost-saving and more compact architecture.

In a preferred embodiment of the invention, the programmable logic component represents an FPGA component (FPGA—“Field Programmable Gate Array”). The advantage is that, when manufacturing the security module, the already known FPGA technology may be applied both with regard to the programmable logic component itself and the programming utilities necessary for its programming. So even if considerable processor power is required operations may be carried out parallel in hardware instead of sequentially in software and may eventually save time.

Another advantageous embodiment of the invention is that, in the programmable logic component by means of programming, there is a comparator device implemented which is comprised by a process and control unit with predetermined and stored comparison data responsible for comparing electronic data exchanged between the several functional components. This embodiment enables the programmable logic component to, for example, detect faulty data exchange and/or unauthorized data exchange and, if necessary, to intervene correctively, e.g. to stop such data exchange. Likewise, depending on the electronic data coming in, the comparison data stored may be adapted. A particular keystroke, for example, or particular data sequence received via network communication may be recognized by the comparator device and may trigger a predefined control function resulting in an adaptation of the control data.

In another preferred embodiment of the invention, the several functional components are designed to represent functional components operating transparently for the devices coupled to the several functional components when exchanging data. This ensures that software running on the personal computer will not be affected by the mere existence of the security module. The software for controlling the personal computer will not have to be adapted for the use with the security module. Another advantage of this embodiment is that a computer virus already located in the software of the personal computer could not discover whether there is a security module installed which should be evaded.

Preferred embodiments are demonstrated in the dependent method claims. The description of the preferred embodiments comprises the advantages of the dependent method claims as well as of the pertaining dependent apparatus claims.

### DESCRIPTION OF PREFERRED EMBODIMENTS

Further aspects of the invention will become apparent from consideration of the ensuing description of preferred embodiments of the invention and from one drawing. The only FIGURE shows a schematic diagram of a security module with a programmable logic component.

According to the FIGURE, a security module 1 includes several functional components comprising a programmable logic component 2, processor terminal 3, a hard disk terminal 4, terminals of peripheral devices 5 and a memory module 6. The security module 1 is integrated in a personal computer 10 equipped with a central processor or alternatively a microprocessor 11, a hard disk 12, a memory 14 and peripheral devices 13. The personal computer 10 may be any kind of computer system with a central processor and a hard disk. The personal computer 10 may be a mobile computer such as a laptop or PDA (PDA—“Personal Digital Assistant”.

The programmable logic component 2 may be realized by means of any kind of programmable logic components (also called PLD—“Programmable Logic Device”) being able to be programmed in order to process electronic data exchanged between the several functional components. The programmable logic component may be programmable only once or several times. Programming with the logic components programmable several times is done by memory cells accommodated in the programmable logic component 2, e.g. SRAM, EPROM, EEPROM and/or flash memory cells. An FPGA component (FPGA—“Field Programmable Gate Array”) is primarily used for the programmable logic component 2. But even a CPLD component (CPLD—“Complex Programmable Logic Device”) or an ASIC component (ASIC—“Application Specific Integrated Circuit”) may be applied.

The processor terminal 3 connected to the programmable logic component 2 serves the data exchange between the security module 1 and the microprocessor 11 of the personal computer 10. If the personal computer 10 comprises several microprocessors, i.e. if it is a so-called multiprocessor computer, the processor terminal 3 may be intended to exchange data either with only one or two or more of the several microprocessors. The processor terminal 3 may even be designed to establish an indirect connection between the programmable logic component 2 and the microprocessor 11. This connection for example may be established via a controller, in particular via a hard disk controller, enabling the microprocessor to keep on exchanging information with the peripheral devices via a controller. This becomes particularly important with those embodiments of the invention in which, although an enquiry of the microprocessor 11 to the hard disk 1 is made via the security module 10, the microprocessor 11 does not take notice of the existence of the security module 10, i.e., when the functional components of the security module 1 for data exchange between the microprocessor 11 and the hard disk 12 operate transparently. For this purpose, the security module 10 has to deceive the microprocessor 11 and simulate functions usually carried out by the hard disk 12. I.e., the security module 10 has to send signals to the microprocessor 11 via the processor terminal 3 which will be interpreted by microprocessor 11 as signals coming right from the hard disk 12.

In addition, the hard disk terminal 4 is connected to the programmable logic component 2 and provides for connecting one or several hard disks 12 of the personal computer 10. The hard disk 12 may be of any technology available, in particular of any size and/or memory capacity, it may even comprise a so-called MicroDrive. Data transfer from and to the hard disk 12 may be effected by means of any commonly used communication standard, such as IDE, EIDE or SATA standards (IDE—“Integrated Drive Electronics”, EIDE—“Enhanced IDE”, SATA—“Serial Advanced Technology Attachments”).

The terminals of the peripheral devices 5 may comprise terminals to any kind of peripheral devices 13 that may be addressed by a personal computer. In particular, these peripheral devices are used for data input, e.g. a keyboard, a mouse, a scanner or the like, and for data output, e.g. a graphics card, a printer, a sound card or the like. However, there may be terminals of the peripheral devices 5 directed to peripheral devices that provide for both data input and data output, such as to internal storage devices (i.e. devices inside the system cover of a personal computer 10) or to external storage devices (i.e. devices outside the system cover of a personal computer 10) as well as to network interface cards with, for example, modem, ISDN and/or LAN functionality.

Particularly network interface cards represent an important source of malicious data, since they connect the personal computer 10 to communication networks. Moreover, due to computer bugs, operating errors or computer viruses and using a network interface card the personal computer 10 may send messages unintentionally to other computer systems connected to the communication network, e.g. by email. That is the reason why one embodiment of the invention is aimed at routing the entire data traffic between the microprocessor 11 of the personal computer 10 and the network interface cards (not shown here in the FIGURE) via the security module 1 whereas this data traffic is controlled and/or monitored by the programmable logic component 2. In this case, network interface cards with any communication standard or communication protocol may be used.

Another embodiment of the invention may particularly aim at one or several network interface cards possessing two or more so-called MAC addresses (MAC—“Media Access Control”). The MAC address is an address allocated to each network interface card during its production process by which the network interface card is addressed on a transmission level of a communication network that is below the transmission level used for the so-called IP addresses (IP—“Internet Protocol”). In order to address a personal computer alternatively on a system management level or on an operating system level, these levels have to be uniquely addressable via a level-dependent MAC address of the network interface card or IP address of the computer. It is an advantage to have several MAC addresses available if an additional network interface card for system management and an additional cable joint necessary herein are to be spared and the IP addressing is not to be changed.

The terminals of the security module 1 comprising the processor terminal 3, the hard disk terminal 4 and the terminals of the peripheral devices 5 may be designed as simple connections. They may, however, at least partly, comprise complicated circuits, e.g., for carrying out protocol and/or level matching operations of the signals to be exchanged. The security module 1 is furnished with means for coding and/or decoding to convert signals between different communications standards used in the personal computer 10. These coding and/or decoding means may be contained in the programmable logic component 2 and/or the connectors.

The memory module 6 provides the programmable logic component 2 with initialization data. In this respect, at least part of the memory module 6 should be a non-volatile module in order not to lose its memory contents after switching off the operating voltage. The initialization data are available for the programmable logic component 2 at any time, in particular immediately after switching on the operating voltage, and they prompt the security module 1 to act independently from external memory components such as the RAM memory of the personal computer 10. The non-volatile memory module may be any kind of memory modules as long as it keeps its contents after switching off the operational voltages. The memory module 6 may as well comprise a flash memory. In principle, it may even be a volatile memory module fed by an energy source of its own such as a battery. The non-volatile memory module may be integrated in the programmable logic component 2 as well.

In addition to the non-volatile memory module, the memory module 6 may also comprise its own volatile memory module such as a RAM memory where the programmable logic component 2 in operation may store data to be used at a later date. This task may also be adopted by a part of memory 14 of the personal computer 10 by reserving this part for the security module 1 during the selfinitialization process of the programmable logic component 2 and by allowing the microprocessor 11 to only access the remaining part of memory 14 freely. In a similar way, a part of the memory capacity of the hard disk 12 may be claimed by the security module 1 as well.

The peripheral devices 13, the hard disk 12 and/or the microprocessor 11 may be addressed by a bus system of the personal computer 10. Particularly in one embodiment of the security module 1 as a PCI plug-in card, separate physical connectors on the security module 1 may be spared.

In order to enable the security module 1 to execute its control and monitoring functions as comprehensive as possible, in one embodiment of the invention, the entire data traffic between the microprocessor 11, the hard disk 12 and the peripheral devices 13 is carried out via the security module 1. For the purpose of computer speed it may be useful that certain data is exchanged without being detoured via the security module 1. If there are, for example, several hard disks, the hard disk containing less important data may also be connected directly to the microprocessor 11.

In order to enable the security module 1 to control and monitor the data traffic of the personal computer 10, as a start, the functional components of the security module 1 have to be put into a defined initial state. After applying an operational voltage, the programmable logic component 2 will be initialized thus setting up a process and control unit in the programmable logic component 2 which is fed with initialization data. The process and control unit controls all the functional components of the security module 1 independently from the microprocessor 11.

After its initialization the programmable logic component 2 will be able to receive data via its interfaces and to compare it with the data stored in the memory module 6 in order to react appropriately such as generating a warning when important data is to be erased.

Initialization of the hard disk 12 by program routines stored in the BIOS, a service program providing an interface between a computer's operating system and the personal computer's hardware, is very important. During initialization of the personal computer 10 (also called booting) technical data of the hard disk 12 such as hard disk memory capacity is inquired via a hard disk controller. This inquiry is received via the processor terminal 3 by the programmable logic component 2 and answered with the help of data stored in memory module 6 referring to hard disk 12. If e.g. an area of the hard disk 12 is occupied by the security module 1, the microprocessor 11 will receive information about the hard disk memory capacity reduced by the amount of space already occupied by the security module 1.

The microprocessor 11 accesses the hard disk 12 in such a way that instructions to the hard disk 12 given by the microprocessor 11 are at first received by the programmable logic component 2 via the processor terminal 3. These instructions are monitored by the process and control unit and compared with the data stored in memory module 6. When the process and control unit discovers a non-allowable operation resulting from an instruction, i.e. when the microprocessor tries to execute an operation which is not allowed, e.g. accessing an area on the hard disk 12 usually not being accessible for the hard disk 12, that instruction will not be fed to hard disk 12. Via the processor terminal 3, the microprocessor 11 will receive an error message instead identical to an error message of hard disk 12. In so doing, the microprocessor 11 is given the illusion that data has been transferred directly between the microprocessor 11 and the hard disk 12. The error message may be a message reporting that the area concerned does not exist. Allowable instructions and data are transferred unchanged to the hard disk 12 via the hard disk terminal 4. This means that the programmable logic component 2, the processor terminal 3 and the hard disk terminal 4 operate transparently.

Data exchange with the peripheral devices 13 for data input and/or data output is performed similarly. Data input may be done, for example, with a keyboard. When pushing a key or several keys like a keyboard shortcut, first the respective signal will be sent to a terminal of the peripheral devices 5 of the security module 1. There the signal is decoded or directly fed to the programmable logic component 2. If the process and control unit of the programmable logic component 2 discovers, after having compared data with the data stored in the memory module 6, that performing the command associated with a certain keyboard shortcut causes actions which are not allowed, the signal will be either completely ignored and/or an appropriate warning will be displayed on another peripheral device, e.g. on a monitor. In so doing, a command may also be given to the process and control unit itself by using it exclusively within the process and control unit to start a software routine, whereas the keystroke command is not transferred to the microprocessor 11. In this way, malicious software running on microprocessor 11 is also prevented from controlling the operation of the process and control unit.

The features of the invention disclosed herein, in the description, the claims and the drawing, individually or in any combination as well, may be of importance for the implementation of the invention in its different embodiments.

1. A security module for controlling and monitoring data traffic of a personal computer comprising several functional components each implemented by hardware and/or software, wherein the several functional components comprise:
a programmable logic component in which, by means of programming, a process and control unit for processing electronic data being exchanged between the several functional components is implemented;
a processor terminal connected to the programmable logic component for exchanging electronic data with a central processor of the personal computer;
a hard disk terminal connected to the programmable logic component for exchanging electronic data with a hard disk of the personal computer;
terminals of peripheral devices connected to the programmable logic component for exchanging electronic data with the peripheral devices for data input and/or data output connected to the personal computer; and
a memory module connected to the programmable logic component and containing initialization data for the logic component;
where the programmable logic component designed to functionalize itself independently in order to make the process and control unit ready for use in the programmable logic component by means of the initialization data.

2.-14. (canceled)
